(19) United States
(12) Patent Application Publication
(10) Pub. No.: US 2025/0272615 A1
(43) Pub. Date: Aug. 28, 2025

(54) DIVISION OF MEASUREMENT DATA RECORDS ACROSS THE PHASES OF THE TRAINING OF A MACHINE LEARNING MODEL

(71) Applicant: Robert Bosch GmbH, Stuttgart (DE)

(72) Inventors: Ernst Kloppenburg, Ditzingen (DE); Konrad Groh, Stuttgart (DE)

(21) Appl. No.: 19/059,427

(22) Filed: Feb. 21, 2025

(30) Foreign Application Priority Data
Feb. 28, 2024 (EP) 24 16 0212.7

(51) Int. Cl. G06N 20/00

(52) U.S. Cl. CPC G06N 20/00

(57) ABSTRACT

A method for dividing a specified set of measurement data records for the training of a machine learning model across different specified phases of the training. Each measurement data record contains values of one or more measurement variables. The method includes: ascertaining a sequence of reference points, which cover a space of the measurement data records and do not coincide with measurement data records; for one or more of the measurement data records, ascertaining, with a specified distance measure, to which reference point this measurement data record is closest, and assigning the measurement data record to this reference point; dividing the reference points across the specified phases of the training so that one or more reference points are assigned to each phase of the training; assigning the measurement data records assigned to a reference point also to the phase of the training to which this reference point is assigned.

### FIELD

The present invention relates to the training of machine learning models, such as neural networks, for the evaluation of measurement data, for example in the context of the at least partially automated driving of vehicles or robots.

### BACKGROUND INFORMATION

The at least partially automated driving of vehicles or robots on company premises or in public transport requires that the environment of the vehicle or robot is constantly monitored by measurement technology and that the measurement data obtained in this way are evaluated with a view to the planning of the further behavior of the vehicle or robot. In particular, machine learning models are used for this evaluation. If such a model is trained with a finite set of training examples with sufficient variability and provides accurate results for these training examples, it is assumed, due to the ability of machine learning models to generalize, that the machine learning model is also capable of accurately evaluating unseen data.

A specified set of training examples can in particular be used, for example, for the training by optimizing the machine learning model on the basis of a portion of the training examples. Another portion of the training examples can be reserved during this optimization and used after completion of the optimization to ascertain the performance of the machine learning model on unseen measurement data.

### SUMMARY

The present invention provides a method for dividing a specified set of measurement data records for the training of a machine learning model across different specified phases of this training. Each measurement data record contains values of one or more measurement variables. Here, the term “record” refers to a collection of values of related measurement variables and other data, comparable to the contents of an index card. The more intuitive term “data set” is already used in the field of machine learning to refer to a set of many records, comparable to a card index box filled with many index cards. The measurement data records can in particular contain, for example, sensor data recorded with sensors of any kind, such as measuring instruments for specific measurement variables, cameras, radar sensors, lidar sensors, or ultrasonic sensors.

The term “machine learning model” in particular refers, for example, to a model that embodies a function that is parameterized with adjustable parameters and has great ability to generalize. When training a machine learning model, the parameters can in particular be adjusted in such a way that, when training data are entered into the model, the target outputs associated with the training data are reproduced as well as possible. A machine learning model may in particular include an artificial neural network (ANN), and/or it may be an ANN.

Within the scope of an example embodiment of the method of the present invention, a sequence of reference points, which cover a space of the measurement data records and do not coincide with measurement data records, is ascertained. In particular, this coverage can, for example, be a uniform coverage. This is understood in particular to mean, for example, that the space of the measurement data records contains neither significant accumulations of reference points nor significant areas that are free of reference points. In particular, the space of the measurement data records can have significantly more dimensions than the three dimensions of the Cartesian space. In this respect, this space can be understood as a hyperspace.

According to an example embodiment of the present invention, for one or more measurement data records from the specified set of measurement data records, it is ascertained, with a specified distance measure, to which reference point this measurement data record is closest. The measurement data record is then assigned to this reference point. In particular, a reference point can then thus be assigned, for example, one or more measurement data records, wherein it is definitely permissible that
one or more measurement data records are not assigned to any reference point, and/or.
one or more reference points are not assigned any measurement data record.

In particular, the distance measure can, for example, be a Euclidean distance measure. However, any other distance measure can also be used, for example a 1-norm.

The reference points are divided across the specified phases of the training so that one or more reference points are assigned to each phase of the training. The measurement data records assigned to a reference point are also assigned to the phase of the training to which this reference point is assigned. Figuratively speaking, during the division across the phases of the training, each reference point obtains a color, and this color is also given to all measurement data records assigned to the corresponding reference point.

It was recognized that measurement data records that are similar to one another and are thus located close to one another in the space of the measurement data records are in this way preferably assigned to the same reference point. This means that these measurement data records are also assigned to the same phase of the training.

Regardless of the specific design of the machine learning model and whether the training is supervised or unsupervised, the training can, for example, in particular comprise.
at least one optimization phase, in which parameters that characterize the behavior of the machine learning model to be trained are optimized, and.
at least one test phase, in which the success of the optimization phase is checked.

This also includes, for example, “k-fold cross-validation,” in which the set of available measurement data records is divided into k equal parts. In this case, in alternation, one of the parts i=1, . . . , k is used for the test phase and the rest of the measurement data records are used for the optimization phase. In common parlance in the field of machine learning, the optimization phase is usually referred to as training. In the context of the present invention, it is, however, more expedient to understand the training as a unit of optimization and subsequent test.

The aim of dividing the training into an optimization phase and a test phase is in particular to counteract the tendency toward so-called overfitting. In particular if only comparatively few measurement data records are available in relation to the size and complexity of the architecture of the machine learning model, the machine learning model can take a path of least resistance in the optimization phase and optimize itself in a way that is closer to “memorizing” the presented measurement data records than to extracting the general knowledge represented therein. The test on measurement data records unseen in the optimization phase is intended in particular to determine whether the trained machine learning model can really generalize or has only “memorized” without the ability to generalize. In order for the test to be informative in this respect, the measurement data records presented in the optimization phase on the one hand and in the test phase on the other hand must differ sufficiently from one another. If essentially the same measurement data records are presented in both phases, the trained machine learning model can pass the test with good results even if it has only “memorized.”

By preferably presenting the same or similar measurement data records for the same phase of the training, it is also favored that different measurement data records are used in the different phases of the training. This means that the machine learning model can no longer achieve a good test result by merely “memorizing.” The error measured during the test is therefore informative about the ability of the trained machine learning model to generalize.

The ability measured in this way is, in turn, an essential criterion for whether the trained machine learning model can be used in the specific application for controlling technical systems, such as vehicles or robots. A good test result is roughly comparable to the sticker that is issued after passing the main inspection and with which a vehicle is approved for use in road traffic. The test, and thus also the preceding division of the total available measurement data records across the different phases of the training, is thus not a mere mathematical division of elements into different sets as such, but an indispensable part of the overall process, which begins with the provision of the specified set of measurement data and leads to the use of the finished machine learning model in the specific technical application.

The measurement data records can optionally be annotated with target outputs (“labels”), which the trained machine learning model should ideally provide when presented with the corresponding measurement data record. The training can then be carried out as “supervised” training in the sense that deviations of the output of the machine learning model from the corresponding target output are considered errors and, if necessary, used as feedback for further optimization. Since the labeling of measurement data records is often a manual and costly process, labeled measurement data records are a scarce resource for supervised training in many applications. Labels can relate to individual measurement data records but also, for example, to trajectory sections of a time series of measurement data records.

For example, a validation phase can optionally be inserted between the optimization phase and the test phase. For example, the optimization phase can be repeated with multiple different hyperparameters, which define, for example, the topology and/or size of the machine learning model or the optimization strategy, and the validation phase can in each case check how changing the hyperparameters affects the performance of the machine learning model. The finally trained machine learning model can subsequently be checked in the test phase, again with different data, and be approved for use.

According to an example embodiment of the present invention, it is particularly advantageous if each measurement data record from the specified set of measurement data records is assigned to a reference point. The available stock of measurement data records is then completely divided across the different phases of the training and thus optimally utilized.

In particular, the specified set of measurement data records can, for example, form a time series or a sequence. The time series or the sequence then already provides clues as to which measurement data records are similar and should therefore be assigned to the same phase of the training.

According to an example embodiment of the present invention, if the measurement data records form a time series, measurement data records can in particular be expanded, for example, in a preprocessing step by one or more further components that indicate a history of the time series. The sequence of reference points can then be ascertained in the space of the thus expanded measurement data records. A further component that indicates a history of the time series can, for example, arise from a low-pass-filtered time series of one or more measurement variables. In this way, for example, for ascertaining the output of the machine learning model, only the measurement data records within a certain past time horizon can be taken into account, while measurement data records even further back in time are disregarded.

According to an example embodiment of the present invention, if the measurement data records form a sequence, which, unlike a time series, only indicates an order in which the measurement data records were recorded and does not have to be annotated with time information, in a further advantageous embodiment, when assigning measurement data records to reference points, an assignment of records following one another in the sequence of records to one and the same reference point is favored. For example, if measurement data are acquired according to an experimental design, this experimental design is usually designed to utilize a specific sequence for efficient measurement. In many cases, such an experimental design also includes stationary phases, in which measurement data records following one another are more similar to one another than measurement data records that are further apart in the sequence. Ascertaining similarity in this way can be more efficient than directly calculating a plurality of distances to reference points in a multidimensional space.

In a further, particularly advantageous embodiment of the present invention, sections of the time series of which measurement data records are in each case closest to a reference point are assigned to this reference point. In this way, a time series of measurement data records can be divided into different parts for use in different phases of the training, wherein the respective measurement data records within these parts are still in the correct order. In particular, this can be used to model a transient system behavior, in which the value of a variable of interest to be predicted by the machine learning model depends at time t on the course (history) of the measurement data records in a past time horizon before time t.

In this case, only sections of the time series that have a specified minimum length measured in time and/or in the number of measurement data records can advantageously be assigned to a reference point and/or assigned to a phase of the training. Sections that are too short can therefore be sorted out when assigning measurement data records to reference points but also when assigning measurement data records to phases of the training. The required minimum length can in particular be ascertained, for example, on the basis of a time constant with which the technical system under consideration responds to changes in its operating conditions represented in the measurement data records.

In a further, particularly advantageous embodiment of the present invention, only measurement data records from a subset (space-filling subset, SFS), covering the space of the measurement data records, of the specified set of measurement data records are assigned to reference points. In this way, the set of measurement data records can be reduced to the essentials, which characterize the behavior of the technical system observed via the measurement data. In particular, an existing SFS can, for example, be divided across the different phases of the training. However, an SFS can, for example, also be newly generated and divided across the different phases of the training in one and the same work process.

For this purpose, it is in particular possible, for example, to assign to each reference point either no measurement data record or the measurement data record closest to this reference point. In this case, there may well be reference points that remain without an assigned measurement data record.

In a particularly advantageous embodiment of the present invention, a random or pseudo-random sequence of reference points is ascertained in the space of the measurement data records. In this way, the reference points are irregularly spaced from one another so that, unlike when lining the space with a regular grid, no artifacts are induced by the regularity of this grid.

It is particularly advantageous to ascertain a Sobol sequence as a sequence of reference points. Such a sequence is characterized in that later reference points lie in the gaps between earlier reference points. Thus, the further the sequence progresses, the more densely the space is progressively covered.

In a further, particularly advantageous embodiment of the present invention, the sequence of reference points is divided in sections across the specified phases of the training. In particular in the context of a Sobol sequence as a sequence of reference points, this has the advantage that each of the sections in turn forms a space-filling sequence. For example, if the sequence of reference points has M reference points, the first p reference points are, for example, assigned to an optimization phase of the training and the other (1-p) reference points are assigned to a test phase of the training.

In a further, particularly advantageous embodiment of the present invention, the measurement data records are scaled in a preprocessing step into a hypercube, in which all coordinates take values in the same value range (for example, between 0 and 1). In this way, when calculating the distance measure that decides the assignment of measurement data records to reference points, all measurement variables occurring in the measurement data records are treated equally, regardless of the order of magnitude of their values. Therefore, no measurement variable can receive a particularly great significance in the distance measure solely on the basis of the fact that all of its measured values are of a particularly great order of magnitude, or it can essentially fall out of the distance measure solely on the basis of the fact that all of its measured values are of a particularly small order of magnitude. Otherwise, the meaning of the individual measurement variables would depend on the choice of unit of measurement (for example, ohms or kilohms, volts or millivolts).

In a further, particularly advantageous embodiment of the present invention, the machine learning model is trained in the specified phases of the training using the measurement data records respectively assigned to these phases. In this way, the improved division of the measurement data records across the phases of the training results in a training success that promises better ability to generalize on data unseen during training.

In a further, particularly advantageous embodiment of the present invention, further measurement data records recorded with at least one sensor are fed to the machine learning model trained in this way. A control signal is ascertained from the output of the machine learning model. A vehicle, a driver assistance system, a robot, a quality control system, a system for monitoring areas, and/or a system for medical imaging is controlled with the control signal. In this way, the probability that the response of the controlled technical system to the control signal is appropriate to the situation represented in the further measurement data records is advantageously increased due to the improved ability of the machine learning model to generalize.

The method can in particular be wholly or partially computer-implemented. The present invention therefore also relates to a computer program comprising machine-readable instructions that, when executed on one or more computers and/or compute instances, cause the computer(s) and/or compute instances to execute the described method of the present invention. In this sense, control devices for vehicles and embedded systems for technical devices, which are also capable of executing machine-readable instructions, are also to be regarded as computers. Compute instances can be virtual machines, containers or serverless execution environments, for example, which can be provided in a cloud in particular.

The present invention also relates to a machine-readable data carrier and/or to a download product comprising the computer program. A download product is a digital product that can be transmitted via a data network, i.e., can be downloaded by a user of the data network, and can, for example, be offered for immediate download in an online shop.

Furthermore, one or more computers and/or compute instances can be equipped with the computer program, with the machine-readable data carrier, or with the download product.

Further measures improving the present invention are explained in more detail below, together with the description of the preferred exemplary embodiments of the present invention, with reference to figures.

### BRIEF DESCRIPTION OF THE DRAWINGS

FIG. 1 shows an exemplary embodiment of the method 100 for dividing a specified set of measurement data records 2 across different specified phases 1a, 1b, 1c of the training of a machine learning model 1, according to an example embodiment of the present invention.

FIG. 2 shows a complete division of a set of measurement data records 2 across an optimization phase 1a and a test phase 1c of the training, according to an example embodiment of the present invention.

FIG. 3 shows a division of only a space-filling subset SFS of a set of measurement data records 2 across an optimization phase 1a and a test phase 1c of the training, according to an example embodiment of the present invention.

### DETAILED DESCRIPTION OF EXAMPLE EMBODIMENTS

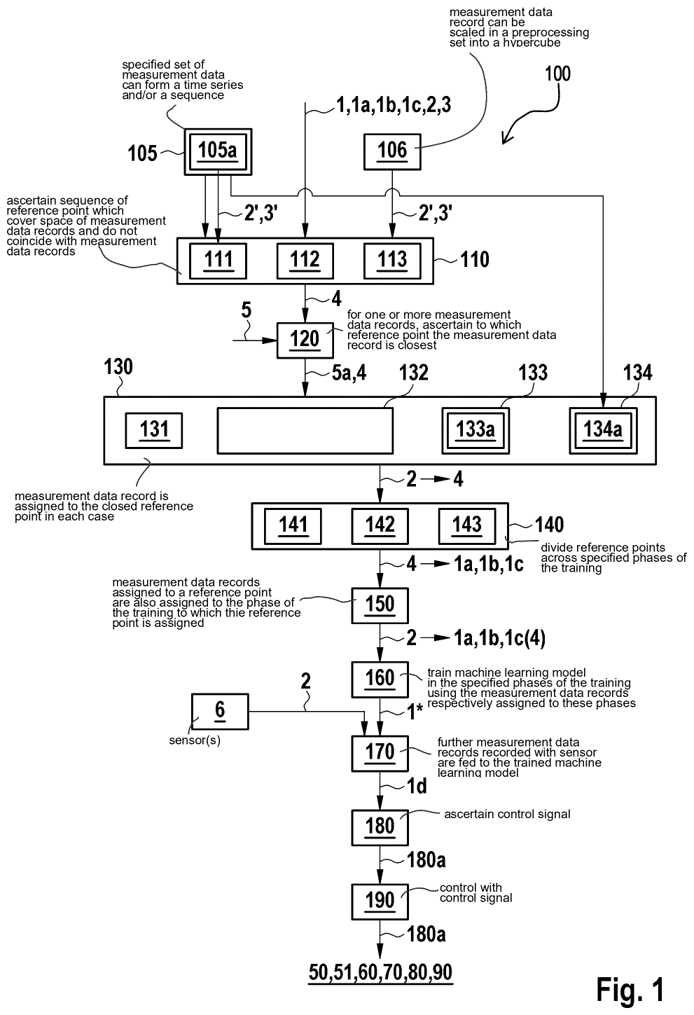

FIG. 1 is a schematic flow chart of an exemplary embodiment of the method 100 for dividing a specified set of measurement data records 2 for the training of a machine learning model 1 across different specified phases 1a, 1b, 1c of this training. Each measurement data record 2 contains values of one or more measurement variables. The measurement data records belong to a space 3.

According to block 105, the specified set of measurement data records 2 can form a time series and/or a sequence. The measurement data records 2 can then be expanded, for example according to block 105a, in a preprocessing step by one or more further components that indicate a history of the time series. The thus expanded measurement data records 2′ belong to a new space 3′.

According to block 106, the measurement data records 2 can be scaled in a preprocessing step into a hypercube, in which all coordinates take values in the same value range. This also creates modified measurement data records 2′ in a new space 3′, which, however, has the same dimensionality as the original space 3.

In step 110, a sequence of reference points 4, which cover a space 3 of the measurement data records 2 and do not coincide with measurement data records 2, is ascertained.

Insofar as the measurement data records 2 according to block 105 were enhanced to form expanded measurement data records 2′ in a space 3′, the sequence of reference points 4 in this space 3′ can be ascertained according to block 111.

According to block 112, a random or pseudo-random sequence of reference points 4 in the space 3 of the measurement data records 2 can be ascertained. In particular, for example, according to block 113, a Sobol sequence can be ascertained as a sequence of reference points 4.

In step 120, for one or more measurement data records 2 from the specified set of measurement data records 2, it is ascertained, with a specified distance measure 5, to which reference point 4 this measurement data record 2 is closest. This creates distances 5a and, accordingly, closest reference points 4. In step 130, the measurement data record 2 is assigned to the closest reference point 4 in each case.

According to block 131, each measurement data record 2 from the specified set of measurement data records 2 can be assigned to a reference point 4.

According to block 132, when assigning measurement data records 2 to reference points 4, an assignment of measurement data records 2 following one another in the sequence of measurement data records 2 to one and the same reference point 4 can be favored.

According to block 133, only measurement data records 2 from a subset SFS, covering the space 3 of the measurement data records 2, of the specified set of measurement data records 2 can, for example, be assigned to reference points 4.

Insofar as a time series of measurement data records 2 is present according to block 105, sections of the time series of which measurement data records 2 are in each case closest to a reference point 4 can be assigned to this reference point 4 according to block 134. In particular, for example according to block 134a, only sections of the time series that have a specified minimum length measured in time and/or in the number of measurement data records 2 can then be assigned to a reference point 4.

In step 140, the reference points 4 are divided across the specified phases 1a, 1b, 1c of the training so that one or more reference points 4 are assigned to each phase 1a, 1b, 1c of the training.

If, according to block 134, sections of the time series of which measurement data records 2 are in each case closest to a reference point 4 are assigned to this reference point 4, only sections of the time series that have a specified minimum length measured in time and/or in the number of measurement data records 2 can, for example, be assigned to a phase 1a, 1b, 1c of the training according to block 141.

According to block 142, the sequence of reference points 4 can be divided in sections across the specified phases 1a, 1b, 1c of the training.

According to block 143,.
at least one optimization phase la, in which parameters that characterize the behavior of the machine learning model 1 to be trained are optimized, and
at least one test phase 1c, in which the success of the optimization phase 1a is checked,
   can be chosen as phases 1a, 1b, 1c of the training. In between, for example, a validation phase 1b can take place, with the help of which, as explained above, the dependence of the performance of the machine learning model 1 on hyperparameters can be examined, for example.

In step 150, the measurement data records 2 assigned to a reference point 4 are also assigned to the phase 1a, 1b, 1c of the training to which this reference point 4 is assigned. In the example shown in FIG. 1, in step 160, the machine learning model 1 is trained in the specified phases 1a, 1b, 1c of the training using the measurement data records 2 respectively assigned to these phases 1a, 1b, 1c. The fully trained state of the machine learning model is denoted by reference sign 1*.

In the example shown in FIG. 1, in step 170, further measurement data records 2 recorded with at least one sensor 6 are fed to the trained machine learning model 1*. Here, the trained machine learning model 1* provides an output 1d. In step 180, a control signal 1d is ascertained from this output 1d. In step 190, a vehicle 50, a driver assistance system 51, a robot 60, a system 70 for quality control, a system 80 for monitoring areas, and/or a system 90 for medical imaging is controlled with the control signal 180a.

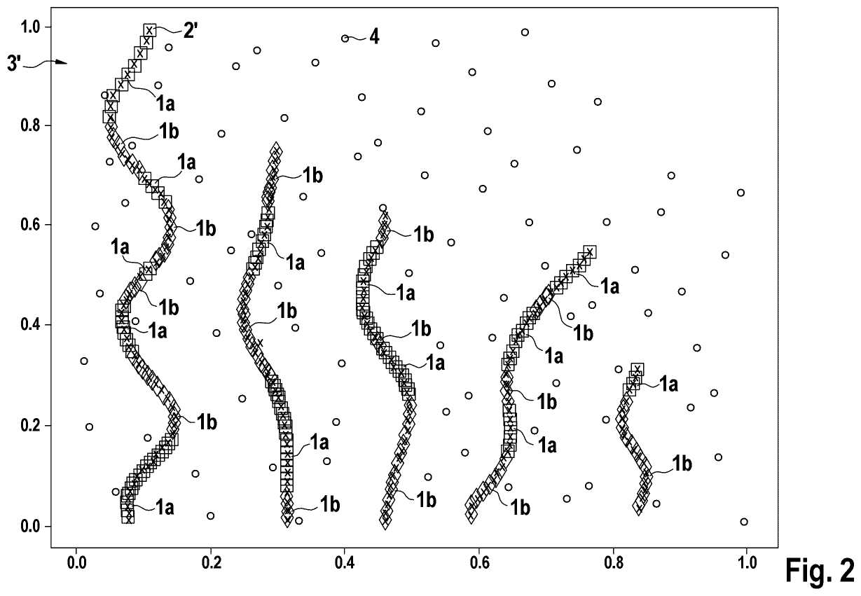

FIG. 2 illustrates how a specified set of measurement data records 2 can be completely divided across an optimization phase 1a and a test phase 1c of the training.

In the example shown in FIG. 2, the measurement data records 2 are scaled into a (here: two-dimensional) unit cube, in which both coordinates can only take values between 0 and 1. This has resulted in modified measurement data records 2′ in a new space 3′, which has the same dimensionality as the original space 3.

The reference points 4 in the space 3′ have been divided across the two phases 1a (optimization phase) and 1b (test phase) of the training here. For this purpose, a section of the sequence of reference points 4 has been assigned to the optimization phase 1a and the rest of the sequence has been assigned to the test phase 1b. Since the sequence of reference points 4 is a Sobol sequence, the space 3′ does not contain any accumulations of reference points 4 belonging to the optimization phase 1a or of reference points 4 belonging to the test phase 1b. Instead, there is a quasi-random mixing of these two categories of reference points 4, the distinction not being shown in FIG. 2 for the sake of clarity.

The measurement data records 2 are assigned to the optimization phase 1a or the test phase 1b depending on whether they are closest to a reference point 4 belonging to the optimization phase 1a or to the test phase 1b. Therefore, the sequence or time series of the measurement data records 2 alternates back and forth in a pseudo-random manner between the optimization phase 1a and the test phase 1b. However, this always creates certain sections of different lengths that belong only to the optimization phase 1a or only to the test phase 1b. Especially applications that deal with time series of measurement data records 2 require sections of such a time series that are at least long enough that the phenomena to be studied can manifest during the respective sections.

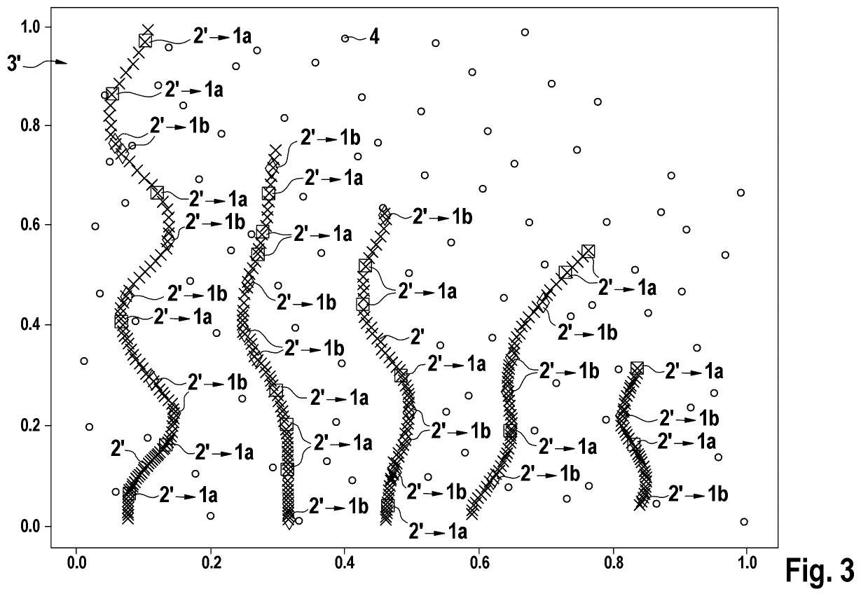

FIG. 3 uses the example of the same set of measurement data records 2 to illustrate how a space-filling subset SFS of this set of measurement data records 2 can be divided across an optimization phase 1a and a test phase 1c of the training.

In FIG. 3, rescaling the measurement data records 2 into the unit cube again created modified measurement data records 2′ in a unit cube, in which both coordinates can only take values between 0 and 1. The new space 3′, which contains these modified measurement data records 2′, has the same dimensionality as the original space 3.

In contrast to FIG. 2, only individual measurement data records 2′ are assigned to the optimization phase 1a or to the test phase 1b. These measurement data records 2′ belong to a space-filling subset SFS that has already been ascertained using the same reference points 4 but otherwise in an arbitrary manner. Like the sections of a sequence of measurement data records 2′ ascertained in FIG. 2, these individual measurement data records 2′ also alternate in a quasi-random manner between the optimization phase 1a and the test phase 1b.

1. Method (100) for dividing a specified set of measurement data records (2) for the training of a machine learning model (1) across different specified phases (1a, 1b, 1c) of this training, wherein each measurement data record (2) contains values of one or more measurement variables, comprising the steps of:
ascertaining (110) a sequence of reference points (4), which cover a space (3) of the measurement data records (2) and do not coincide with measurement data records (2);
for one or more measurement data records (2) from the specified set of measurement data records (2), ascertaining (120), with a specified distance measure (5), to which reference point (4) this measurement data record (2) is closest, and assigning (130) the measurement data record (2) to this reference point (4);
dividing (140) the reference points (4) across the specified phases (1a, 1b, 1c) of the training so that one or more reference points (4) are assigned to each phase (1a, 1b, 1c) of the training;
assigning (150) the measurement data records (2) assigned to a reference point (4) also to the phase (1a, 1b, 1c) of the training to which this reference point (4) is assigned.

2. Method (100) according to claim 1, wherein each measurement data record (2) from the specified set of measurement data records (2) is assigned (131) to a reference point (4).

3. Method (100) according to one of claims 1 to 2, wherein the specified set of measurement data records (2) forms (105) a time series and/or sequence.

4. Method (100) according to claim 3, wherein, when assigning measurement data records (2) to reference points (4), an assignment of measurement data records (2) following one another in the sequence of measurement data records (2) to one and the same reference point (4) is favored (132).

5. Method (100) according to one of claims 3 to 4, wherein
measurement data records (2) are expanded (105a) in a preprocessing step by one or more further components that indicate a history of the time series, and.
the sequence of reference points (4) in the space (3′) of the thus expanded measurement data records (2′) is ascertained (111).

6. Method (100) according to claim 3, wherein sections of the time series of which measurement data records (2) are in each case closest to a reference point (4) are assigned (134) to this reference point (4).

7. Method (100) according to claim 6, wherein only sections of the time series that have a specified minimum length measured in time and/or in the number of measurement data records (2) are assigned (134a) to a reference point (4) and/or are assigned (141) to a phase (1a, 1b, 1c) of the training.

8. Method (100) according to claim 1, wherein only measurement data records (2) from a subset SFS, covering the space (3) of the measurement data records (2), of the specified set of measurement data records (2) are assigned (133) to reference points (4).

9. Method (100) according to claim 8, wherein each reference point (4) is assigned (133a) either no measurement data record (2) or the measurement data record (2) closest to this reference point (4).

10. Method (100) according to one of claims 1 to 9, wherein a random or pseudo-random sequence of reference points (4) in the space (3) of the measurement data records (2) is ascertained (112).

11. Method (100) according to one of claims 1 to 10, wherein a Sobol sequence is ascertained (113) as the sequence of reference points (4).

12. Method (100) according to one of claims 1 to 11, wherein the sequence of reference points (4) is divided (142) in sections across the specified phases (1a, 1b, 1c) of the training.

13. Method (100) according to one of claims 1 to 12, wherein the measurement data records (2) are scaled (106) in a preprocessing step into a hypercube, in which all coordinates take values in the same value range.

14. Method (100) according to one of claims 1 to 13, wherein.
at least one optimization phase (1a), in which parameters that characterize the behavior of the machine learning model (1) to be trained are optimized, and.
at least one test phase (1c), in which the success of the optimization phase (1a) is checked,
are chosen (143) as phases (1a, 1b, 1c) of the training.

15. Method (100) according to one of claims 1 to 14, wherein the machine learning model (1) is trained (160) in the specified phases (1a, 1b, 1c) of the training using the measurement data records (2) respectively assigned to these phases (1a, 1b, 1c).

16. Method (100) according to claim 15, wherein.
the trained machine learning model (1*) is fed (170) further measurement data records (2) recorded with at least one sensor (6),
a control signal (180a) is ascertained (180) from the output (1b) of the machine learning model (1), and
a vehicle (50), a driver assistance system (51), a robot (60), a system (70) for quality control, a system (80) for monitoring areas, and/or a system (90) for medical imaging is controlled (190) with the control signal (180a).

17. Computer program containing machine-readable instructions that, when executed on one or more computers and/or compute instances, cause the computer(s) and/or compute instance(s) to execute the method (100) according to one of claims 1 to 16.

18. Machine-readable data carrier and/or download product comprising the computer program according to claim 17.

19. One or more computers and/or compute instances comprising the computer program according to claim 17 and/or comprising the machine-readable data carrier and/or download product according to claim 18.
